(19) United States
(12) Patent Application Publication
(10) Pub. No.: US 2012/0173150 A1
(43) Pub. Date: Jul. 5, 2012

(54) SENSOR-BASED SYSTEMS AND METHODS FOR ASSESSING INTERNAL BRIDGE DECK DETERIORATION

(76) Inventors: Francisco Romero, Glen Gardner, NH (US); Steven Di Benedetto, Silver Spring, MD (US)

(21) Appl. No.: 13/222,608

(22) Filed: Aug. 31, 2011

Related U.S. Application Data
(60) Provisional application No. 61/378,885, filed on Aug. 31, 2010.

(51) Int. Cl. G06F 19/00; G01V 1/30; G01S 13/88

(52) U.S. Cl. 702/14; 702/34

(57) ABSTRACT

An interior volume of a bridge deck is probed using a transportable sensor system that produces deck data useful for assessing internal degradation of the bridge deck. Geographic position data of sensor system positioning is produced as the sensor system traverses the deck. The deck data is associated with the one or more deck locations using the geographic positioning data, and adjusted deck data is generated using adjustment data indicative of external factors that influence the deck data but are unrelated to a failure mechanism impacting the bridge deck interior. An output may be generated comprising at least the adjusted deck data.

### RELATED PATENT DOCUMENTS

This application claims the benefit of Provisional Patent Application Ser. No. 61/378,885 filed on Aug. 31, 2010, to which priority is claimed under 35 U.S.C. §119(e), and which is incorporated herein by reference.

### SUMMARY

Embodiments of the invention are directed to systems and methods for quantitatively assessing bridge deck condition. Embodiments of the invention are directed to systems and methods for acquiring bridge deck data that facilitates quantitative assessment of internal bridge deck deterioration over time.

In accordance with various embodiments, an apparatus is supportable by a transport unit capable of traversing a highway route that includes a highway bridge having a bridge deck. The apparatus includes a sensor system configured to probe an interior volume of the bridge deck to produce deck data useful for assessing internal degradation of the bridge deck. A geographic positioning unit is configured to determine a geographic position of the sensor system as the transport unit and the sensor system traverse the deck. A memory is configured to store geographic positioning data and the deck data provided by the geographic positioning unit and the sensor system, respectively. A processor is configured to associate the deck data with the one or more deck locations using the geographic positioning data, and generate adjusted deck data using adjustment data indicative of external factors that influence the deck data but are unrelated to a failure mechanism impacting the bridge deck interior. The processor is further configured to generate an output comprising at least the adjusted deck data.

Method embodiments involve probing an interior volume of the bridge deck using a transportable sensor system to produce deck data useful for assessing internal degradation of the bridge deck, and determining a geographic position of the sensor system as the sensor system traverses the deck. Method embodiments further involve associating the deck data with the one or more deck locations using the geographic positioning data, and generating adjusted deck data using adjustment data indicative of external factors that influence the deck data but are unrelated to a failure mechanism impacting the bridge deck interior. Method embodiments may further involve generating an output comprising at least the adjusted deck data.

According to other embodiments, an apparatus is supported by a transport unit capable of traversing a highway route that includes a highway bridge having a bridge deck. The sensor system is configured to probe an interior volume of the bridge deck at one or more deck locations and to produce deck data useful for assessing internal degradation of the bridge deck. A geographic positioning unit is configured to determine a geographic position of the sensor system as the transport unit and the sensor system traverse at least the deck. A time reference is configured to generate a time stamp indicative of a time when deck data and geographic positioning data are acquired. A memory is configured to store geographic positioning data the deck data, and time stamp data provided by the geographic positioning unit, the sensor system, and the time reference, respectively. A processor is configured to associate the deck data with the one or more deck locations using the geographic positioning data and the time stamp data, and to generate time-stamped geographic positioning and deck data sets (data sets).

An apparatus may further include a database configured to store a plurality of time-separated data sets for each bridge of a multiplicity of bridges of a highway transportation network. Preferably, at least one of the data sets for each bridge defines a baseline data set for the bridge. A processor is configured to compare, for each bridge, the baseline data set to one or more of the data sets developed subsequent in time to the baseline data set for the bridge and produce deterioration data based on the comparison. The deterioration data preferably indicates a degree of bridge deck deterioration having occurred between times when the respective data sets were developed based on their respective time stamps. An output may be generated, said output including an indication of bridge deck deterioration for each bridge of the transportation network.

In some embodiments, the database may be configured to store time-separated data sets for each bridge that are separated in time by at least about 1-3 years. In other embodiments, the database may be configured to store time-separated data sets for each bridge that are separated in time by at least about 3-6 years. In further embodiments, the database may be configured to store time-separated data sets for each bridge that are separated in time by up to at least about 10 years. The processor may be configured to prioritize the bridges in terms of deterioration severity based on the deterioration data stored in the database. The processor may be configured to prioritize maintenance requirements for the plurality of bridges based on the deterioration data stored in the database.

These and other features can be understood in view of the following detailed discussion and the accompanying drawings.

### BRIEF DESCRIPTION OF THE DRAWINGS

FIG. 1 shows a cut-away section of a bridge deck containing reinforced concrete;

FIG. 2 is an example of a deterioration map based on attenuated return signals acquired from a sensor system in accordance with various embodiments;

FIG. 3 is an example of an information table that contains various data for bridges within a transportation network in accordance with various embodiments;

FIG. 4 is a flowchart showing various processes for determining bridge deck data adjusted for external factors in accordance with various embodiments;

FIG. 5 shows a block diagram of systems for implementing the processes described in FIG. 4 in accordance with various embodiments;

FIG. 6A shows a flowchart that describes various processes for acquiring deterioration data for a bridge deck interior in accordance with various embodiments;

FIG. 6B is a flowchart of various processes for acquiring and producing deterioration data for a bridge deck interior in accordance with embodiments of the invention;

FIG. 6C is a flowchart that includes the processes of FIG. 6B, with two additional processes in accordance with various embodiments;

FIG. 7 illustrates a block diagram of systems for implementing rate of deterioration determinations for a bridge deck according to various embodiments;

FIG. 8 shows detailed representations of databases for first and second systems illustrated in FIG. 7 in accordance with various embodiments;

FIG. 9 shows a detailed view of the representative databases shown in FIG. 7 in accordance with various embodiments;

FIG. 10A is a bridge deck deterioration map based on attenuated return signals acquired from a sensor system in accordance with various embodiments;

FIGS. 10B, 10C and 10D show deterioration maps representative of bridge deck data for a region A of the bridge deck shown in FIG. 10A obtained at times t1, t2, and t3, respectively, subsequent to time t0, in accordance with various embodiments;

FIG. 11 shows a flowchart illustrating a method for ranking bridges in a highway transportation network based on bridge deck deterioration in accordance with various embodiments;

FIG. 12 illustrates a flow chart of a method for allowing access to bridge deck deterioration data for multiple users in accordance with various embodiments; and

FIG. 13 shows a system diagram in accordance with various embodiments.

### DETAILED DESCRIPTION

In the following description of the illustrated embodiments, references are made to the accompanying drawings forming a part hereof, and in which are shown by way of illustration, various embodiments by which the invention may be practiced. It is to be understood that other embodiments may be utilized, and structural and functional changes may be made without departing from the scope of the present invention.

Systems, devices or methods according to the present invention may include one or more of the features, structures, methods, or combinations thereof described herein. For example, a device or system may be implemented to include one or more of the advantageous features and/or processes described below. It is intended that such a device or system need not include all of the features described herein, but may be implemented to include selected features that provide for useful structures, systems, and/or functionality.

According to 2007 National Bridge Inventory (NBI) data produced by the Federal Highway Administration (FHWA) of the U.S. Department of Transportation (DOT), over 152,000 bridges in the United States are ranked as deficient. Transportation managers and bridge owners are currently faced with the difficult challenges of determining which of these bridges need the greatest attention and how best to allocate limited rehabilitation and maintenance resources. Numerous techniques are currently used to conduct bridge inspection in an attempt to rate individual bridges within a transportation network. The federally-mandated and most commonly utilized assessment methods include biennial visual inspections performed by teams led by professional engineers in accordance with National Bridge Inventory scoring practices. Such methods, however, are not geared towards a quantification of actual deterioration (e.g., deterioration rate or acceleration calculations) of the bridge's components and identification of those assets most rapidly deteriorating. This hinders the ability to plan for future maintenance because detailed predictions of remaining service life are not available.

Bridge decks are an important part of any individual bridge system because their condition state and maintenance often affects underlying structure. Decks serve the important purpose of protecting the bridge superstructure and components of the substructure from the elements, deicing chemicals, and other damage. Also, decks are the portion of the bridge that the public travels over and has the most experience with, and their condition, if poor, can impact safety and vehicle repair costs significantly. Deck repairs contribute significantly to the overall repair costs of bridges over their lifetime. Obtaining a baseline reference against which future internal condition assessments can be compared is important in order to reduce the maintenance backlog, which is now based almost solely on late-stage visual inspection methods and follow-on decisions.

Visual condition scores of the bridge deck, underside, and substructures currently provide the criteria for making bridge deck management decisions within a defined transportation network or corridor. However well they are performed, visual inspections fall short of providing objective, quantitative decision-making criteria which enable uniform standards to be used for prioritizing funding and appropriate resource allocation to bridge systems at both the project and network levels. Part of this is simply due to the fact that bridge inspectors, though properly trained and certified for the work, provide subjective data based on visual interpretations that are not always repeatable from one inspector to the next, even when inspectors are from the same firm. Second, visual techniques provide no way to directly assess the internal condition of the reinforced concrete components even with the most objective, accurate visual condition inspection of the deck and exposed reinforced concrete surfaces.

Visual inspection can indeed identify those specific areas where surface defects are manifesting some degree of internal deterioration, (e.g., spalling caused by corrosion of reinforcing steel bars). However, internal deterioration that has already commenced may not reveal any surface signs for years until after significant internal damage is already done and the bridge then requires more expensive and disruptive repair/rehabilitation versus simpler preventative maintenance such as washing and sealing.

Numerous AASHTO (American Association of State Highway and Transportation Officials) and ASTM (American Society for Testing and Materials) Standard Guides exist for the use of ground penetrating radar (GPR) over pavements and bridge decks (e.g., ASTM D4748-98; ASTM D6807-05, AASHTO R37-04, AASHTO PP-40), demonstrating acceptance of GPR within the transportation assessment and engineering community. Assessing individual bridges using GPR is particularly helpful when considering full-depth or partial repair, rehabilitation or replacement of an entire deck or a deck overlay. However well established existing GPR practices may be, there is currently no temporal component to calculate a rate of interior deck deterioration. Embodiments of the invention provide for data analysis processes that significantly minimize or remove the subjective visual element of determining which decks have internally changed the most since they were last surveyed.

Embodiments of the invention are directed to systems and methods for quantitatively assessing bridge deck condition. Embodiments of the invention are directed to systems and methods for acquiring bridge deck data that facilitates quantitative assessment of internal bridge deck deterioration over time. Embodiments of the invention are directed to systems and methods for processing bridge deck data and computing quantitative assessment data indicative of internal bridge deck deterioration over time. Embodiments of the invention are directed to systems and methods for providing access to bridge deck data and generating output, such as textual and graphical data, using the bridge deck data.

For example, embodiments of the invention are directed to bridge deck condition assessment based upon the rate of bridge deck deterioration calculated from a time-series analysis of sensor data, such as radar data. The analysis may be used to provide bridge deck condition assessment at the bridge network-level based upon the rate of bridge deck deterioration or may be performed for a single bridge. A multiplicity of bridge deck regions can be subject to bridge deck condition assessment according to embodiments of the invention, and each bridge deck region can be monitored and analyzed for deterioration status, rate and/or acceleration over time. An overall assessment of bridge deck condition/deterioration for each bridge can be computed based on an aggregate analysis performed for the multiplicity of bridge deck regions. Embodiments of the invention may be used for assessing individual bridges at the project level within transportation networks and can facilitate the consideration of full-depth or partial repair, rehabilitation or replacement of an entire deck or a deck overlay.

A wide variety of sensors may be employed in systems that implement bridge deck condition assessment using time-series analysis in accordance with embodiments of the invention. Suitable sensors include those capable of collecting data from the surface of a bridge deck, preferably using non-destructive evaluation (NDE) methods. Particularly useful sensors include those that generate a probe signal and sense for a reflected or return signal. The following is a non-exhaustive, non-limiting list of representative sensors that, alone or in combination, may be adapted for bridge deck condition assessment in accordance with embodiments of the invention: a radar sensor such as GPR, impact-echo/micro-seismic sensors, infrared thermography sensors, and video cameras.

Preferred sensors include those that can be used to acquire deck data while traveling along a bridge at normal traffic speeds. For example, various GPR sensor embodiments provide the benefit that no traffic lane closures are required, since data collection can be performed at posted highway speeds, eliminating the need, expense, and safety risks associated with creating work zones during the data collection phase. A GPR sensor system that includes an air-launched antenna arrangement may be used to acquire internal bridge deck data at posted highway speeds, for example. Additionally, because of the speed of data acquisition, bridge deck data can be collected for dozens of bridges per day within a transportation network or corridor during a single deployment.

Sensor data may be used for assessing various aspects of bridge integrity. For example, sensor data may be used to identify regions of a bridge deck where delamination of concrete and corrosion of reinforcing steel is most likely taking place or is already fairly advanced, and regions where sensor data suggests or indicates that weakening of concrete tensile strength may be taking place.

Various embodiments of the invention involve comparing sensor data periodically collected over the same network of bridges and determining the changes in areal extent and degree of deterioration between subsequent sensor data (e.g., datasets) to rapidly identify decks that are undergoing accelerated change. Rate and acceleration of bridge deck deterioration may be calculated by a difference analysis based on the top rebar mat reflection strength amplitude. This analysis may be performed using baseline sensor data previously collected, interpreted, and archived, followed up by data collection and analysis several years (e.g., 1-3 years, 3-6 years, or up to at least 10 years) after the initial baseline data were gathered. It is preferable to use the same or similar sensor hardware and software systems for data collection and analysis over the evaluation term.

A time-series approach to quantifying and mapping bridge deck areas identified as experiencing a high rate of deterioration observed between assessments in accordance with embodiments of the invention represents a significant advancement toward the goal of systematically incorporating sensor technology (e.g., GPR) as a more objective decision-making tool alongside existing roadway management processes. Implementation of sensor technologies and analysis techniques in accordance with the present invention provides for the calculation of a metric or metrics that facilitate identification of regions within each deck that have experienced the most change, and quantifying of some or all of the maximum, mean, and minimum rates of deterioration for each deck, as well as among all the decks within the entire surveyed transportation network.

According to some embodiments, changes in one or more deck deterioration metrics (e.g., maximum, mean, and minimum rates of deterioration) can be used to formulate an internal deck condition index, such as an index similar or corresponding to the National Bridge Inventory (NBI) condition rating system for ranking decks. Such an index for internal deck condition characterization can be examined over time and compared to previous ratings to calculate a deterioration rate or acceleration for individual bridge decks and the network as a whole. Internal deck condition indices and related data can be used to supplement bridge deck assessment indices and data determined using traditional visual assessment methodologies. Internal deck condition indices and related data acquired and managed in accordance with embodiments of the invention can be easily integrated into various States' Bridge Management Systems, the NBI database, and/or existing asset management software.

The NBI is a collection of database information covering just under 600,000 of the Nation's bridges located on public roads, including Interstate Highways, U.S. highways, State and county roads, as well as publicly-accessible bridges on Federal lands. The NBI presents a state-by-state summary analysis of the number, location, and general condition of highway bridges within each state. The Federal Highway Administration of the U.S. Department of Transportation has established National Bridge Inspection Standards (NBIS) for the safety inspection and evaluation of highway bridges. Each state is required to conduct periodic inspections of all bridges subject to the NBIS, prepare and maintain a current inventory of these structures, and report the data to the FHWA using the procedures and format outlined in the Recording and Coding Guide for the Structure Inventory and Appraisal of the Nation's Bridges. The FHWA provides each state with a list of bridges that are eligible for replacement or rehabilitation based on NBI data. NBI data also enables the FHWA to satisfy statutory requirements that mandate the inventory, classification, cost estimates for replacement or rehabilitation, and assignment of replacement or rehabilitation priorities for all highway bridges on all public roads.

The NBI codes listed in Table 1 below are used to describe the overall condition rating of a bridge deck in accordance with the USDOT FHWA's “Recording and Coding Guide for the Structure Inventory and Appraisal of the Nation's Bridges,” Report No. FHWA-PD-96-001, page 37:

TABLE 1

| Code | Description |
|---|---|
| N | NOT APPLICABLE |
| 9 | EXCELLENT CONDITION |
| 8 | VERY GOOD CONDIITION—no problems noted. |
| 7 | GOOD CONDITION—some minor problems. |
| 6 | SATISFACTORY CONDITION—structural elements show some |
| | deterioration |
| 5 | FAIR CONDITION—all primary structural elements are sound |
| | but may have minor section loss, cracking, spalling or scour. |
| 4 | POOR CONDITION—advanced section loss, deterioration, |
| | spalling or scour. |
| 3 | SERIOUS CONDITION—loss of section, deterioration, spalling or |
| | scour have seriously affected primary structural components. Local |
| | failures are possible. Fatigue cracks in steel or shear cracks in |
| | concrete may be present |
| 2 | CRITICAL CONDITION—advanced deterioration of primary |
| | structural elements. Fatigue cracks in steel or shear cracks in |
| | concrete may be present or scour may have removed substructure |
| | support. Unless closely monitored it may be necessary to close |
| | the bridge until corrective action is taken. |
| 1 | “IMMINENT” FAILURE CONDITION—major deterioration or |
| | section loss present in critical structural components or obvious |
| | vertical or horizontal movement affecting structure stability. |
| | Bridge is closed to traffic but corrective action may put back in |
| | light service. |
| 0 | FAILED CONDITION—out of service—beyond corrective action. |

Concerning bridge decks, in particular, page 38 of the FHWA's Recording and Coding Guide states the following:

### Item 58—Deck 1 Digit

This item describes the overall condition rating of the deck. Rate and code the condition in accordance with the above general condition ratings. Code N for culverts and other structures without decks e.g., filled arch bridge.
Concrete decks should be inspected for cracking, scaling, spalling, leaching, chloride contamination, potholing, delamination, and full or partial depth failures. Steel grid decks should be inspected for broken welds, broken grids, section loss, and growth of filled grids from corrosion. Timber decks should be inspected for splitting, crushing, fastener failure, and deterioration from rot.
The condition of the wearing surface/protective system, joints, expansion devices, curbs, sidewalks, parapets, fascias, bridge rail, and scuppers shall not be considered in the overall deck evaluation. However, their condition should be noted on the inspection form.

Page 37 of the FHWA's Recording and Coding Guide describes the manner in which bridge deck condition ratings are to be used:

Items 58 through 62—Indicate the Condition Ratings
In order to promote uniformity between bridge inspectors, these guidelines will be used to rate and code Items 58, 59, 60, 61, and 62. The use of the AASHTO Guide for Commonly Recognized (CoRe) Structural Elements is an acceptable alternative to using these rating guidelines for Items 58, 59, 60, and 62, provided the FHWA translator computer program is used to convert the inspection data to NBI condition ratings for NBI data submittal.
Condition ratings are used to describe the existing, in-place bridge as compared to the as-built condition. Evaluation is for the materials related, physical condition of the deck, superstructure, and substructure components of a bridge. The condition evaluation of channels and channel used when they provide an overall characterization of the general condition of the entire component being rated. Conversely, they are occurring instances of deterioration or disrepair. Correct assignment of a condition code must, therefore, consider both the severity of the deterioration or disrepair and the extent to which it is widespread throughout the component being rated.

The FHWA's Recording and Coding Guide is explicit in describing proper and improper use of bridge deck condition ratings. As is set forth hereinabove, the FHWA's Recording and Coding Guide states that condition codes are “properly used” when they provide an overall characterization of the general condition of the entire component being rated, and are “improperly used” if they attempt to describe localized or nominally occurring instances of deterioration or disrepair.

Embodiments of the invention provide for localized and overall characterization of bridge deck condition, which can significantly improve the capability of federal, state, and local agencies to more accurately characterize bridge deck condition/deterioration and more effectively appropriate resources to maintain bridges and bridge networks in proper condition. Embodiments of the invention can provide for localized and overall characterization of bridge deck condition using non-destructive evaluation apparatus and techniques. Embodiments of the invention can further provide for rapid acquisition of bridge deck condition data in a manner that does not adversely impact traffic over bridges, which represents a significant advantage when nearly 600,000 bridges require periodic assessment in accordance with FHWA requirements.

In accordance with various embodiments, a time-series approach to bridge deck condition assessment involves determining how much variability can be produced within bridge deck sensor data based solely upon environmental and external factors or conditions unrelated to actual deterioration of the deck. Such factors include seasonal factors that change during the year (e.g., temperature, moisture, deicing chemicals) and variability relating to sensor data acquisition (e.g., GPR antenna path wander that affects the internal variability of GPR data), among others.

Embodiments of the invention involve acquiring data indicative of external factors or conditions that influence bridge deck data but are unrelated to a failure mechanism impacting the bridge deck interior, and generating adjusted bridge deck condition data using the external factor data. The adjusted bridge deck condition data represents bridge deck sensor data that is filtered using the external factor data. The adjusted bridge deck condition data can provide enhanced bridge deck deterioration data relative to non-adjusted bridge deck condition data, it being understood that both forms of bridge deck condition data provide valuable information concerning the internal condition of a bridge deck.

In embodiments that use external factor data to filter bridge deck condition data, it can be assumed that a significant change of the internal deck condition index (or deterioration metric) relative to an index/metric generated from previously conducted surveys is due to degradation of the bridge deck structure. Furthermore, areas of the bridge deck evidencing the greatest overall changes are indicative of regions where the localized rate of degradation is likewise significantly elevated above the mean rate of change in the overall bridge deck structure within that same time frame. Regions of the bridge deck experiencing an elevated localized rate of degradation represent areas where greater attention should be focused to determine the source of the elevated degradation.

A time-series assessment of bridge deck condition in accordance with embodiments of the invention is based on the premise that once cured, the interior components of any bridge are going to deteriorate in quality as the concrete cracks, moisture and deicing chemicals infiltrate, and the steel reinforcement begins to corrode. In the context of GPR sensor embodiments, this deterioration will manifest primarily in GPR data as a difference in the amplitude of the reflected radar signal off of the rebar mat between successive GPR surveys.

According to various embodiments of the present invention, bridge deck condition assessment and external factor adjustment of bridge deck data involves probing an interior volume of bridge deck at one or more locations. The return signal from the probe is stored in a memory as deck data. The location and time of acquisition of each of the probes is also stored with respect to the return signal associated with that location. In various embodiments of the invention, the return signal that is stored may be altered by a coefficient that represents known external factors that may influence the return signal data. The adjusted data is then stored in memory.

Many different external factor coefficients may be stored in memory to account for variability that can be produced within bridge deck data based upon environmental and external factors unrelated to actual deterioration of the deck. These external factors may include, for example, temperature, moisture, deicing chemicals, and antenna path wander, among others as previously discussed.

In some embodiments, the rate of deterioration is determined by comparing deck data from at least one point in time to deck data from a previous point in time. The deck data from a previous point in time can be referred to as “baseline data.” The change in deck data at a particular location per unit time is determined. The result from this calculation is output as deterioration data and indicates the rate of change of deterioration for a particular bridge deck location. It is also understood that a higher order rate of change may be used such as the acceleration bridge deck deterioration.

Systems and methods of the invention are directed to ranking bridges in a bridge network in order of the rate of deterioration. It is also understood that the acceleration of the deterioration may be used in addition to or instead of the rate of deterioration to rank the bridges in the bridge network. Bridge ranking typically involves computing one or more metrics or indices (e.g., NBI condition code) indicative of bridge deck condition/deterioration for a network of bridges using sensor-based interior deck assessment data and optionally visual inspection metrics or indices. These rankings may be used for prioritizing funding and/or appropriate resources for more intensive assessment and/or repairs to bridge systems.

In order to facilitate the ranking of bridges in a bridge network, several different deterioration values may be taken into consideration for each bridge. These various deterioration values may be associated with various locations within a deck of a bridge. In order to rank the bridges, the average rate of deterioration for each bridge may be determined based on the different deterioration values at various locations of the bridge's deck. The bridge in a bridge network with the highest average deterioration value may be ranked as the first bridge to be scheduled for additional assessment and/or maintenance. The minimum and the maximum values of deterioration may also be determined for each bridge in a bridge network to determine the ranking of the bridges.

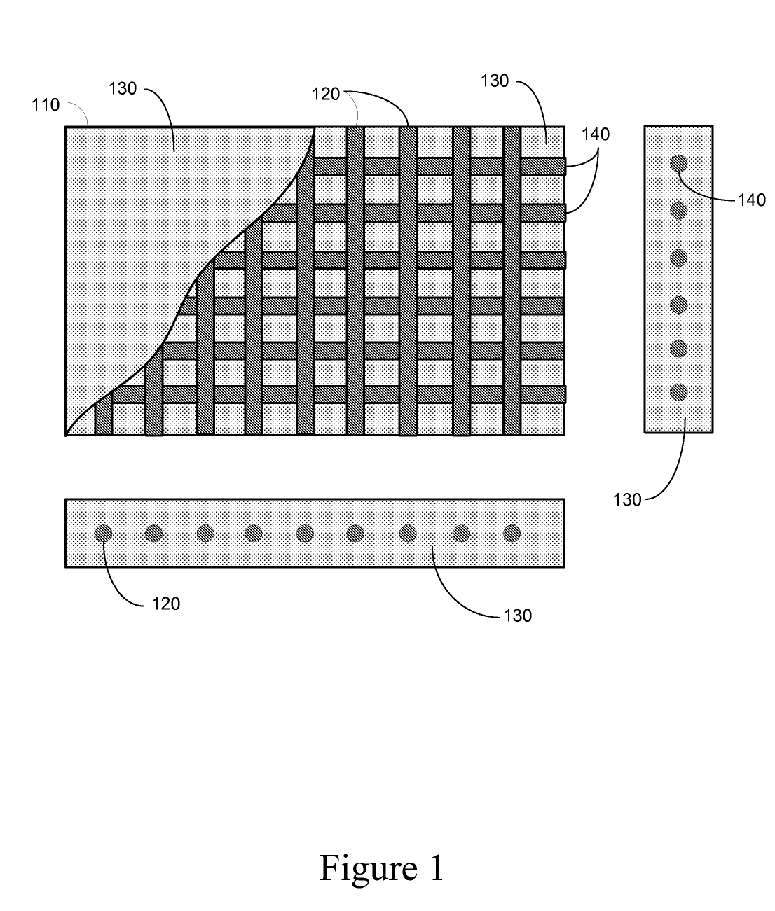

Turning now to FIG. 1, this figure shows a cut-away section of a bridge deck 110 containing reinforced concrete. The bridge deck has a concrete surface 130 that is cut away in this figure in order to show the layers underneath. As can be observed in FIG. 1, a reinforced concrete bridge deck can contain one or more longitudinal rebars 140, and one or more transverse rebars 120. There may also be more than one layer of longitudinal rebars 140 and more than one layer of transverse rebars 120. In FIG. 1, the transverse rebars are affixed to the top of the longitudinal rebars, but in another example the longitudinal rebars may be affixed to the top of the transverse rebars. In a different layer of the bridge deck shown in FIG. 1, the longitudinal rebars may be affixed to the top of the transverse rebars. Underneath a rebar layer is a bottom layer of concrete 130.

Embodiments of the invention are directed to sensing a return signal reflected off at least one layer of rebar. The travel time of the reflected return signal resulting from a probe signal is related to depth of the rebar layer. The magnitude of the return signal is inversely related to the degree of corrosion and deterioration of the rebar layer.

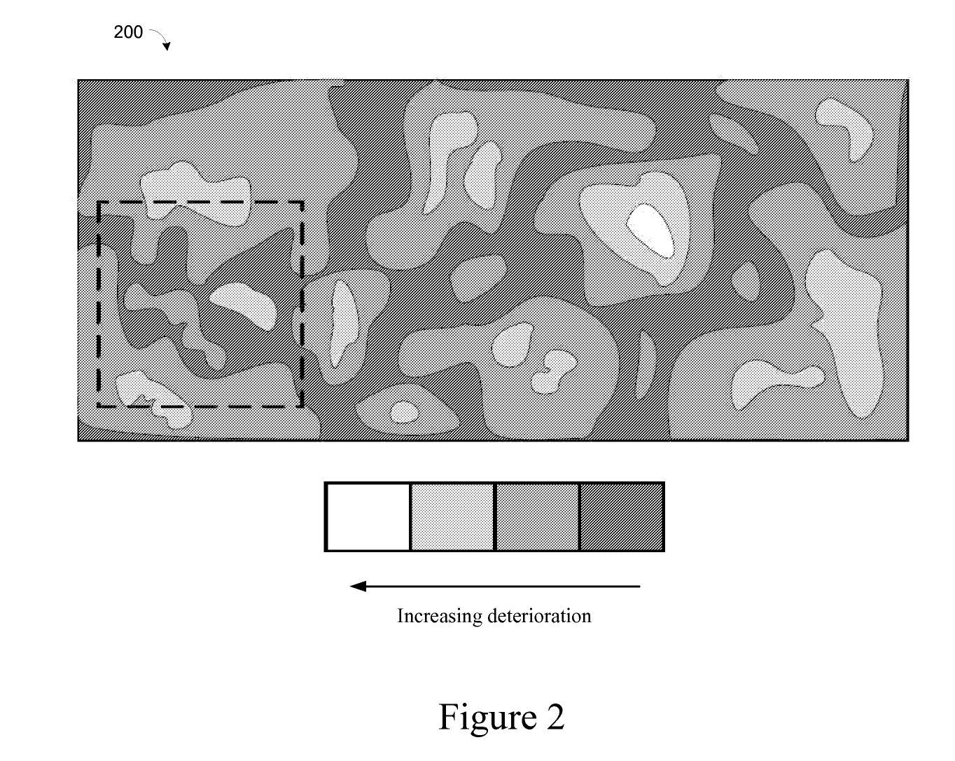

FIG. 2 is an example of a deterioration map based on attenuated return signals acquired from a sensor system. The deterioration map shown in FIG. 2 can be used to calculate deterioration in several ways, such as a percentage of deck area based upon radar signal attenuation at the top rebar mat. Quantified deck deterioration metrics can be computed based on the data from which the deterioration map is generated and/or from the contour lines or surface profile of the map (e.g., metrics based on one or both of two- and three dimensional bridge deck data). The representative contour map 200 shown in FIG. 2 represents a portion of a bridge deck from an aerial view. In this illustrative example, it can be observed that the lighter areas on the map correspond to increased bridge deck deterioration.

According to various embodiments of the invention, a sensor system is used to probe a bridge deck. The probe signal is used to sense reinforced concrete components of the bridge deck interior. The sensor system may also be configured to sense at least a top surface of a rebar mat or cage. The return signal attenuation is preferably measured from at least the top surface of the rebar mat. This attenuated return signal acquired at one point in time can be compared to an attenuated return signal acquired for the same bridge location at an earlier point in time. A difference in the earlier and later attenuated return signals is indicative of a relative change in bridge deck deterioration that has occurred during successive surveys. According to various embodiments, a GPR system is configured to generate a radar probe signal and measure radar return signal attenuation of at least the top surface of a rebar mat of the bridge deck interior.

In some embodiments, the magnitude of the return signal is compared to a “baseline” return signal. A baseline return signal refers to a return signal that was collected at an earlier point in time (e.g., 3 years previously). The more significant the difference between a current return signal and the baseline return signal, provided the current return signal is weaker (attenuated) relative to the baseline signal, the more deterioration has taken place. A “best-case” scenario describes a situation where little or no change in concrete condition has taken place, and is represented by a region displaying the lowest return signal attenuation possible. A return signal that is slightly more attenuated (weaker return signal) relative to the best-case scenario, where little or no signal attenuation has taken place, may represent slight deterioration of the bridge deck (e.g., a rating change from “good” to “fair”). A return signal that is significantly attenuated compared with the baseline signal which once again showed little or no signal attenuation over time, may represent major bridge deck deterioration (e.g., a rating change from “good” to “poor” or “fair” to “serious”), where different qualitative ratings (good, fair, poor, serious) can be assigned to quantitative signal attenuation measurements.

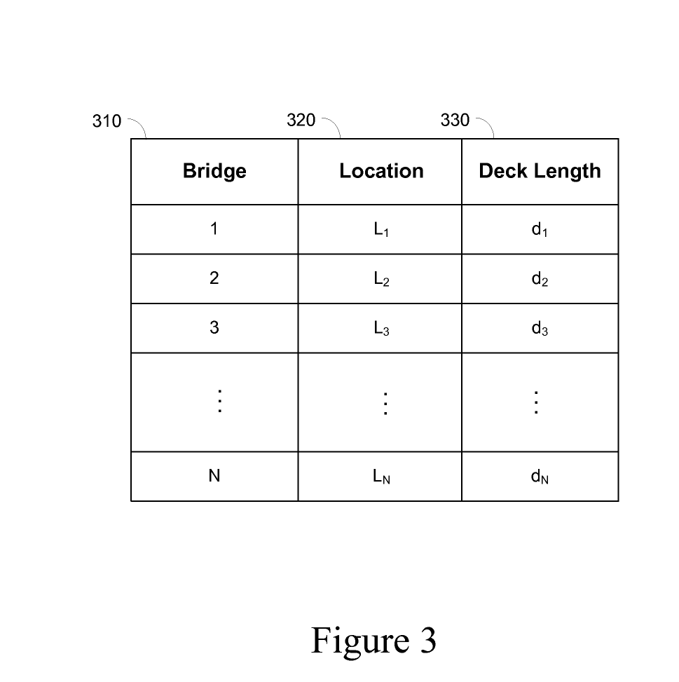

FIG. 3 is an example of an information table that contains various data for bridges within a transportation network. A transportation network may include bridges on a specific transportation corridor on a stretch of highway. In FIG. 3, there are N bridges in the bridge network and the bridges are labeled 1 to N. The location 320 of each of the bridges 310 in the bridge network is also listed. This location could refer to a mile marker on the highway that the bridge starts at, for example. This location may also refer to the geographical location (latitude and longitude) of the bridge, which may be determined using a GPS (global positioning system) sensor or other positioning instrument. The deck length 330 for each bridge in the network is also listed. For example, bridge 1 starts at location L₁ and has a deck length of d₁.

Network bridges are typically located on a specific highway stretch so travelers on that stretch would be crossing over the bridges in FIG. 3 in succession. According to embodiments of the invention, an entire bridge network is analyzed in order to determine deterioration of the network as a whole. The deterioration of each bridge within a network may also be analyzed in order to determine additional assessment and/or maintenance priorities for individual bridges within a bridge network. Collecting data of multiple bridges in the same time period serves to reduce the chances for outside factors to influence the data and all of the bridges in a network can be compared equally.

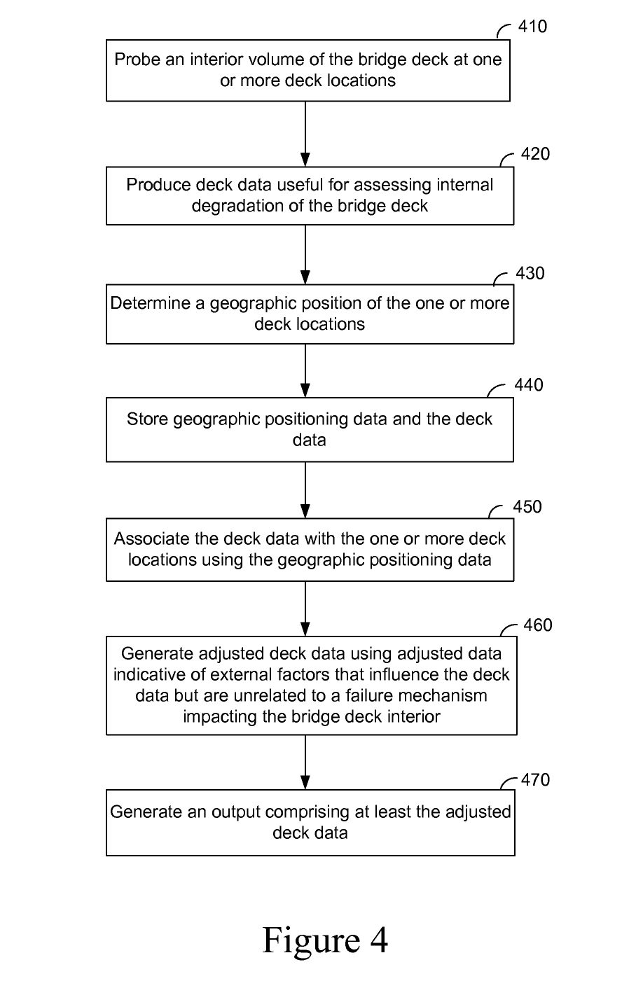

FIG. 4 is a flowchart showing various processes for determining bridge deck data adjusted for external factors in accordance with embodiments of the invention. According to FIG. 4, an interior volume of the bridge deck is probed 410 at one or more deck locations. Deck data useful for assessing internal degradation of the bridge deck is produced 420. Geographic locations of the one or more deck locations are determined 430. Geographic positioning data and the deck data are stored 440. Adjusted deck data is generated 460 using adjusted data indicative of external factors that influence the deck data but are unrelated to a failure mechanism impacting the bridge deck interior. An output is generated 470 comprising at least the adjusted deck data. Adjusting the deck data to effectively filter out variability that can be produced within bridge deck sensor data based solely upon environmental and external factors unrelated to actual deterioration of the deck can advantageously enhance the accuracy of internal deck deterioration data acquired and produced in accordance with embodiments of the invention.

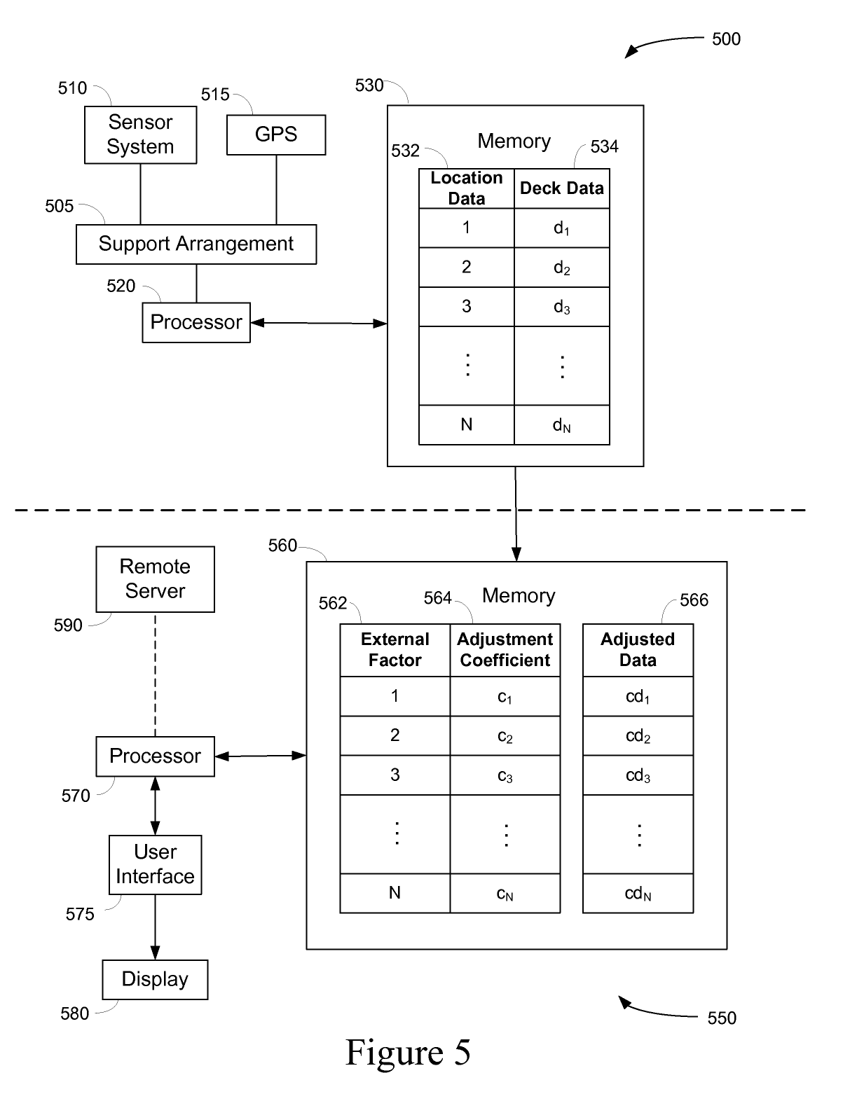

Referring to FIG. 5, there is shown a block diagram of systems 500 and 550 for implementing the processes described in FIG. 4 in accordance with embodiments of the invention. Systems 500 and 550 may be separate stand-alone systems (e.g., 2 or more systems) or they may be embodied in a single or common system. The first system 500 represents a system for collecting bridge deck data at various locations of a bridge deck.

The first system 500 includes a support arrangement 505 configured to support the various elements of the first system 500. For example, the support arrangement 505 may be configured to support a sensor system 510, a geographic positioning system 515, and a processor 520 coupled to memory 530. In one embodiment, the support arrangement 505 may be a transport unit capable of traversing a highway route that includes a highway bridge. For example, the transport unit may be a vehicle capable of traversing a highway route that includes a highway bridge at posted road speeds. Alternatively, the transport unit may be capable of being carried by an operator to a location on a bridge deck to be scanned.

The first system 500 also includes a sensor system 510 comprising one or more sensors. The sensor system 510 may include one or a multiplicity of the same or disparate sensors that generate a probe signal and sense for a reflected return signal. The sensor system 510 may include one or a multiplicity of the same or disparate sensors that scan a bridge deck without need for probe signal generation. The reflected return signal and/or scan signal is preferably stored in memory 530 as deck data 534. The following is a non-exhaustive, non-limiting list of representative sensors that may be adapted for bridge deck condition assessment in accordance with embodiments of the invention: a radar sensor such as GPR, impact-echo/micro-seismic sensors, infrared thermography sensors, and video cameras.

According to some embodiments, a multiplicity of sensor systems supporting disparate sensors may be used to acquire bridge deck data, along with positioning data that identifies the location of each sensor at the time of data acquisition. Sensor data for multiple sensors may be acquired concurrently or at different times. A GPS or other positioning system may be deployed with each sensor so that the location of each sensor is accurately measured. Data acquired by each of the disparate sensor systems is preferably communicated to a processor which is configured to perform data fusion on the disparate sensor data. The processor may be coupled to the sensor system or be a processor of a separate system, such as a laptop, a desktop, or a server system. Fusion can be implemented at one or several stages during sensor data processing. Additional details for performing fusion in the context of various embodiments of the invention are disclosed in U.S. Pat. Nos. 6,751,553 and 5,321,613, which are incorporated herein by reference.

The first system 500 may also comprise a GPS sensor 515 to determine the location of the sensor system 510 and store the location information in memory 530 as location data 532. The GPS sensor 515 may also be used to store the location of each sensor in the sensor system 510 when each sensor is actively sensing the bridge deck. The location paired with a sensor scan may be used to compare past scans at the same location. The first system 500 also includes a processor 520 coupled to memory 530. The memory 530 can be a computer readable medium encoded with a computer program, software, computer executable instructions, instructions capable of being executed by a computer, etc., such as by processor 520. Execution of the computer program by processor 520 causes the processor 520 to associate the stored deck data 534 with the location data 532 in memory.

The second system 550 may be implemented as a stand-alone system(s) or may be incorporated into the first system 500. The deck data 534 associated with the location data 532 is received and stored in memory 560 of the second system 550. The second system 550 includes a processor 570 coupled to memory 560. The second system 550 may also include a user interface 575 that facilitates user interaction with the system 550. According to various embodiments, the user interface 575 allows the user to enter in an external factor 562 that was present during the probing of the deck data 534. This may be effected by way of entering the condition name or entering a symbol or number that is associated with that external factor 562. External factors, as discussed previously, refer to conditions that are unrelated to actual deterioration of the deck that may influence sensor data, such as GPR return signal data. These external factors may include, for example, temperature, moisture, deicing chemicals, and antenna path wander. In some embodiments, at least some of the external factor data can be received from a sensor, external memory, or processing device via a hardwire or wireless connection.

Each external factor 562 stored in memory 560 is associated with an adjustment coefficient 564 corresponding to that external factor 562. In some embodiments, a user may be enabled to manually enter one or more of the deck data 534, adjustment coefficient data 564, and external factor data 562.

The memory 560 can be a computer readable medium encoded with a computer program. Execution of the computer program by processor 570 causes the processor 570 to determine the adjustment coefficient based on the chosen external factor or condition 562. Execution of the computer program by the processor 570 may also cause the processor 570 to create adjusted data by multiplying the adjustment coefficient 564 with the deck data 534 associated with the location data 532 to produce adjusted data 566 that is also stored in memory 560. It is noted that the adjustment coefficient 564 may comprise a single adjustment coefficient or multiple adjustment coefficients. For example, a number of adjustment coefficients can be used to adjust a corresponding number of variables that may define a particular external factor (e.g., tap weights of a tap weight filter).

The second system 550 may also comprise a display 580 coupled to the user interface 575. In some embodiments, a list of external factors 562 may be presented on the display 580 allowing a user to choose external factors 562 using the user interface 575. Once the adjusted data 566 is created, the adjusted data 566 may also be presented on the display 580 for a user to view or edit.

In various embodiments of the second system 550, the data 532, 534, 562, 564, 566 stored in memory 530, 560 may be transported to a remote server 590. The remote server 590 may be accessible by many different users that may have an interest in the data 532, 534, 562, 564, 566. User access to bridge deck data 532, 534, 562, 564, 566 may be restricted to authorized users.

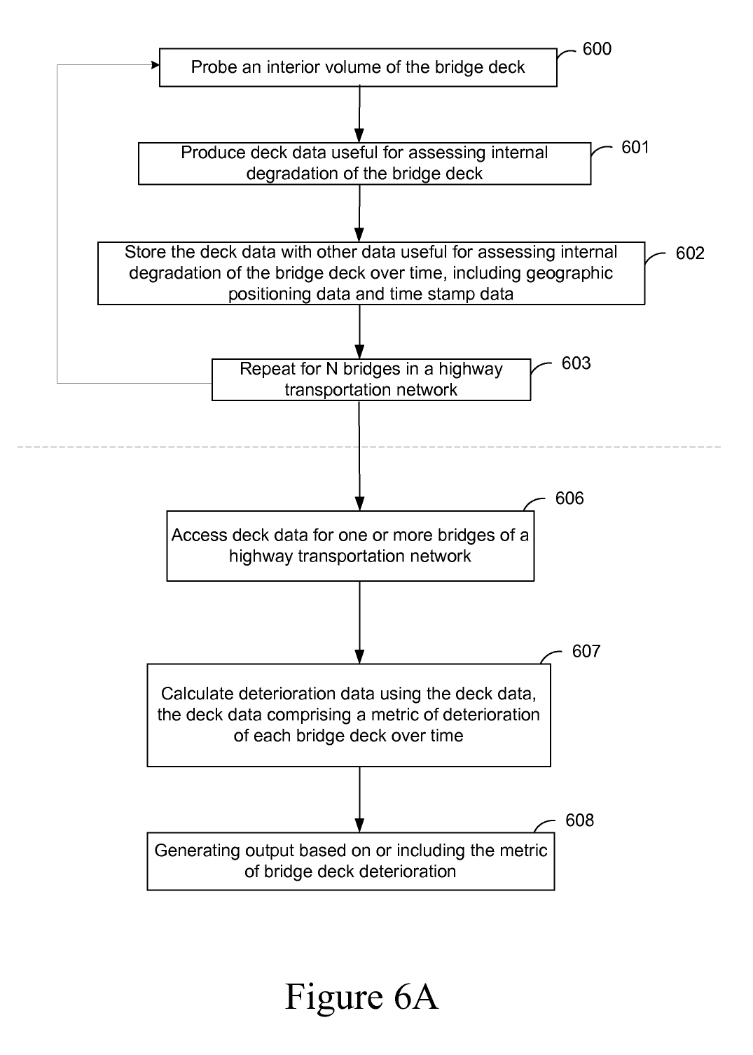

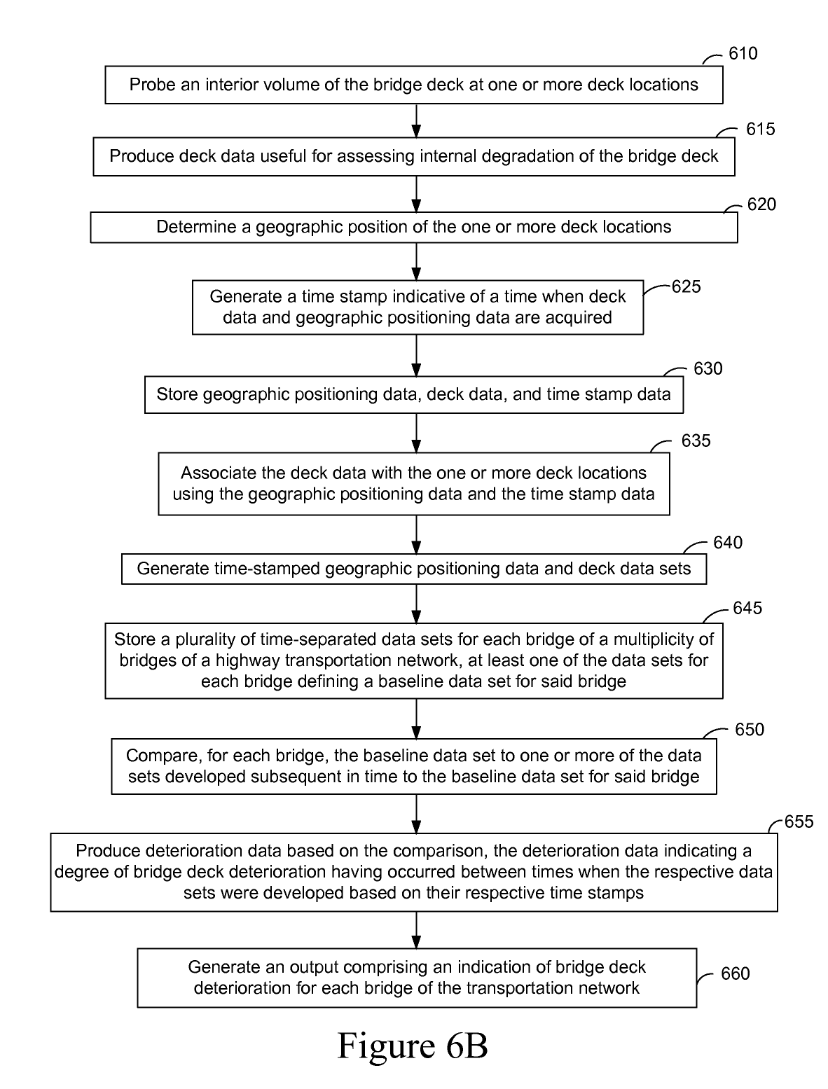

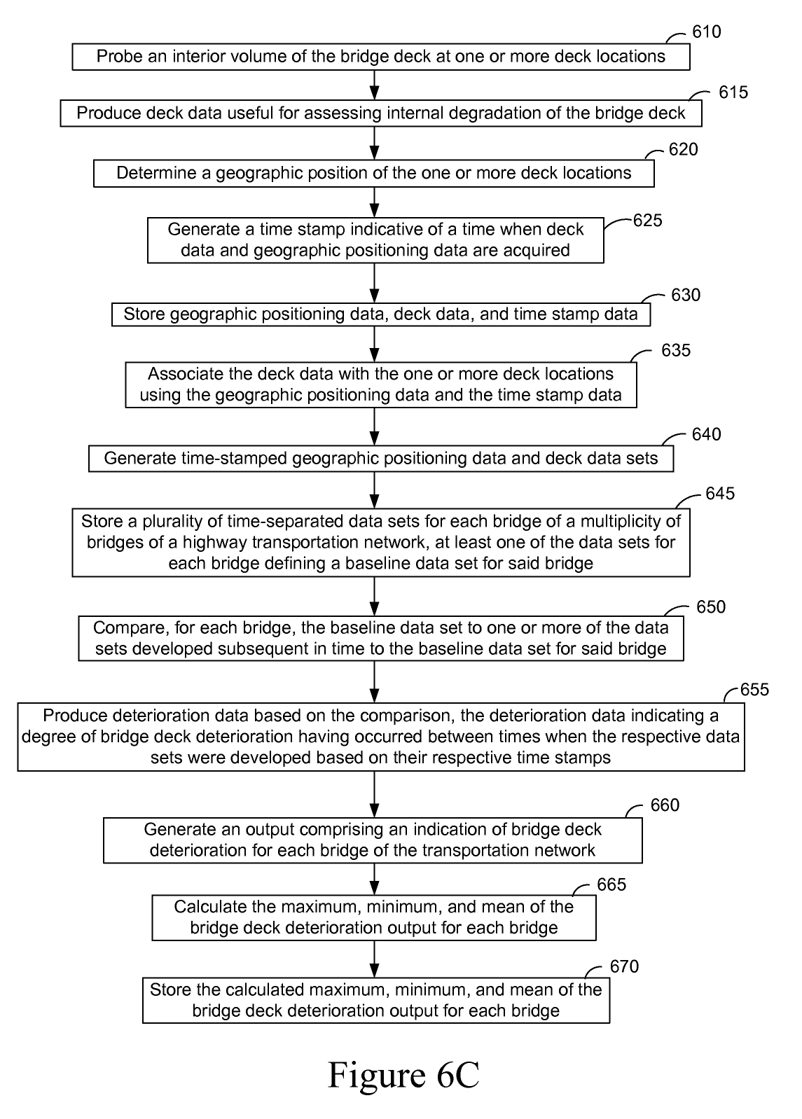

Turning now to FIG. 6A, there is shown a flowchart that describes various processes for acquiring deterioration data for a bridge deck interior in accordance with embodiments of the invention. FIG. 6A also shows various processes for algorithmically assessing bridge deck deterioration using acquired bridge deck deterioration data.

According to FIG. 6A, a sensor system is configured to probe 600 an interior volume of a bridge deck at one or more deck locations and to produce 601 deck data useful for assessing internal degradation of the bridge deck. Deck data is stored 602 along with other data useful for assessing internal degradation of the bridge deck over time, such as geographic positioning data and time stamp data. Processes 600-602 are repeated for each of N bridges in a highway transportation network.

FIG. 6A further shows various processes for algorithmically assessing bridge deck deterioration and generating an output based on the assessment. At block 606, deck data is accessed for one or more bridges of a highway transportation network. Deterioration data is calculated 607 using the deck data, the deck data comprising a metric of deterioration of each bridge deck over time. An output is generated 608 based on or including the metric of bridge deck deterioration. The output may be a signal, data, a display, a report, or other form of output.

FIG. 6B is a flowchart of various processes for acquiring and producing deterioration data for a bridge deck interior in accordance with embodiments of the invention. According to FIG. 6B, a sensor system is configured to probe 610 an interior volume of the bridge deck at one or more deck locations and to produce 615 deck data useful for assessing internal degradation of the bridge deck. A geographic positioning unit is configured to determine 620 a geographic position of the one or more deck locations. A time reference is configured to generate 625 a time stamp indicative of a time when deck data and geographic positioning data are acquired. Memory is configured to store 630 geographic positioning data the deck data, and time stamp data provided by the geographic positioning unit, the sensor system, and the time reference, respectively. The deck data is associated 635 with the one or more deck locations using the geographic positioning data and the time stamp data. Time stamped geographic positioning data and deck data sets are generated 640.

Time-separated data sets for each bridge of a multiplicity of bridges of a highway transportation network are stored 645 where at least one of the data sets for each bridge defines a baseline data set for said bridge. The baseline data set for each bridge is compared 650 to one or more of the data sets developed subsequent in time to the baseline data set for said bridge. Deterioration data based on the comparison 650 is produced 655 where the deterioration data indicates a degree of bridge deck deterioration having occurred between times when the respective data sets were developed based on their respective time stamps. An output is generated 660 comprising an indication of bridge deck deterioration for each bridge of the transportation network.

FIG. 6C is flowchart that includes the steps of FIG. 6B, with two additional steps as follows. A maximum, median, and mean of the bridge deck deterioration is calculated 665 for each bridge in the transportation network. The maximum, median, and mean of the bridge deck deterioration are stored 670 for each bridge in the transportation network. A maximum deterioration and a minimum deterioration may also be calculated based on all of the bridges in a bridge network.

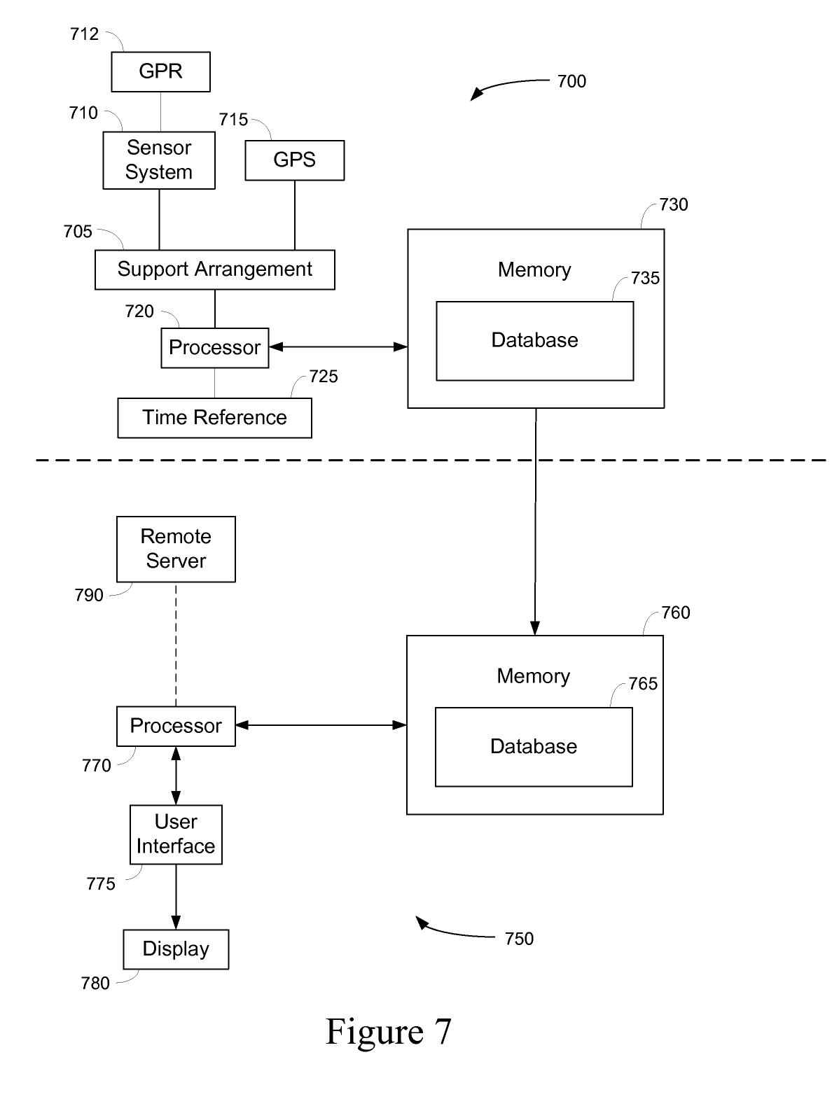

FIG. 7 illustrates a block diagram of systems 700 and 750 for implementing rate of deterioration determinations for a bridge deck according to various embodiments of the invention. Systems 700 and 750 may be two separate stand-alone systems or they may be embodied in a single or common system. The first system 700 represents a system for collecting deck data at various locations of a bridge deck for a multiplicity of bridges.

The first system 700 includes a support arrangement 705 configured to support the various elements of the first system 700. For example, the elements supported by the support arrangement 705 may include a sensor system 710, a geographic positioning system 715, and a processor 720 coupled to memory 730. In one embodiment, the support arrangement 705 may be a transport unit capable of traversing a highway route that includes a highway bridge. As with other embodiments described hereinabove, the transport unit may be a vehicle capable of traversing the highway route that includes a highway bridge at posted road speeds. Alternatively, the transport unit may be capable of being carried by an operator to a location on a bridge deck to be scanned.

The first system 700 includes a sensor system 710 comprising one or more sensors. The sensor system 710 may include sensors that generate a probe signal and sense for a reflected return signal and/or sensors that scan for one or more characteristics of a bridge deck interior. In the embodiment shown in FIG. 7, the sensor system 710 comprises a GPR sensor 712, but may include other sensors or other types of sensors in addition to the GPR sensor 712 (e.g., impact-echo/micro-seismic sensors, infrared thermography sensors, video cameras). The sensor system 710 may additionally include other sensors that are capable of sensing conditions unrelated to actual deterioration of the deck that may influence the return signal data, such as temperature sensors, moisture sensors, and deicing chemical sensors. The sensor system 710 or other component may sense for and measure variations that can occur for certain types of sensors, such as antenna path wander for GPR sensors. The reflected return signals from the GPR sensor 712 are stored in memory 730.

The first system 700 also comprises a GPS sensor 715 that can determine the location of the sensor system 710 and store the locations in memory 730. A time reference 725 determines the time at which the probe signal was generated. A GPS location paired with a GPR sensor scan may be used to compare past scans at the same location. The first system 700 also includes a processor 720 coupled to memory 730. The memory 730 can be a computer readable medium encoded with a computer program, software, computer executable instructions, instructions capable of being executed by a computer, etc., such as by processor 720. Execution of the computer program by processor 720 causes the processor 720 to associate the stored deck data with the location and time data in memory 730. Memory 730 may additionally include a database 730 to store the reflected return signal data or deck data, the location data, the time stamp data, and external factor data (if any).

The second system 750 may be a stand-alone system or may be incorporated into the first system 700. The deck data associated with the location data and time data is received and stored in memory 760 of the second system. The second system also includes a processor 770 coupled to memory 760. The second system 750 may also include a user interface 775 for a user to interact with the system.

The memory 760 can be a computer readable medium encoded with a computer program such as processor 770. Execution of the computer program by processor 770 causes the processor 770 to compare, for each bridge, baseline data to the deck data that is associated with a location and a time. The baseline data is typically deck data for a given bridge deck that is associated with an earlier timestamp that shares the same location. Baseline data may have been established 1-3 years prior, for example. In some cases, baseline data may have been established 3-6 years ago or up to at least 10 years prior, for example.

Execution of the computer program stored in memory 760 may further cause the processor 770 to produce deterioration data based on the comparison of the deck data to the baseline data, where the deterioration data indicates a degree of bridge deck deterioration having occurred between the times when the deck data was obtained when the baseline data was established. The deterioration data is further stored in the database 765. Execution of the computer program by processor 770 additionally causes the processor to generate an output comprising an indication of bridge deck deterioration for each bridge of the transportation network.

According to some embodiments, execution of the computer program by processor 770 additionally causes the deterioration data to be adjusted using an adjustment coefficient. The adjustment coefficient may be calculated based on external factors unrelated to the deterioration of the bridge deck that were present at the time of the sensor readings.

The second system may also comprise a user interface 775 and a display 780 that may be used to enable a user to reference a particular bridge's deck data, deterioration data, and/or baseline data. The user interface 775 may also be used to reference and display a plurality of bridge's deck data, deterioration data, and/or baseline data. This may further enable a user to analyze the data and/or enter new data. According to some embodiments of the present invention the second system 750 includes a remote server. The remote server may be used to enable a plurality of users in disparate locations to access the data stored in the database 765.

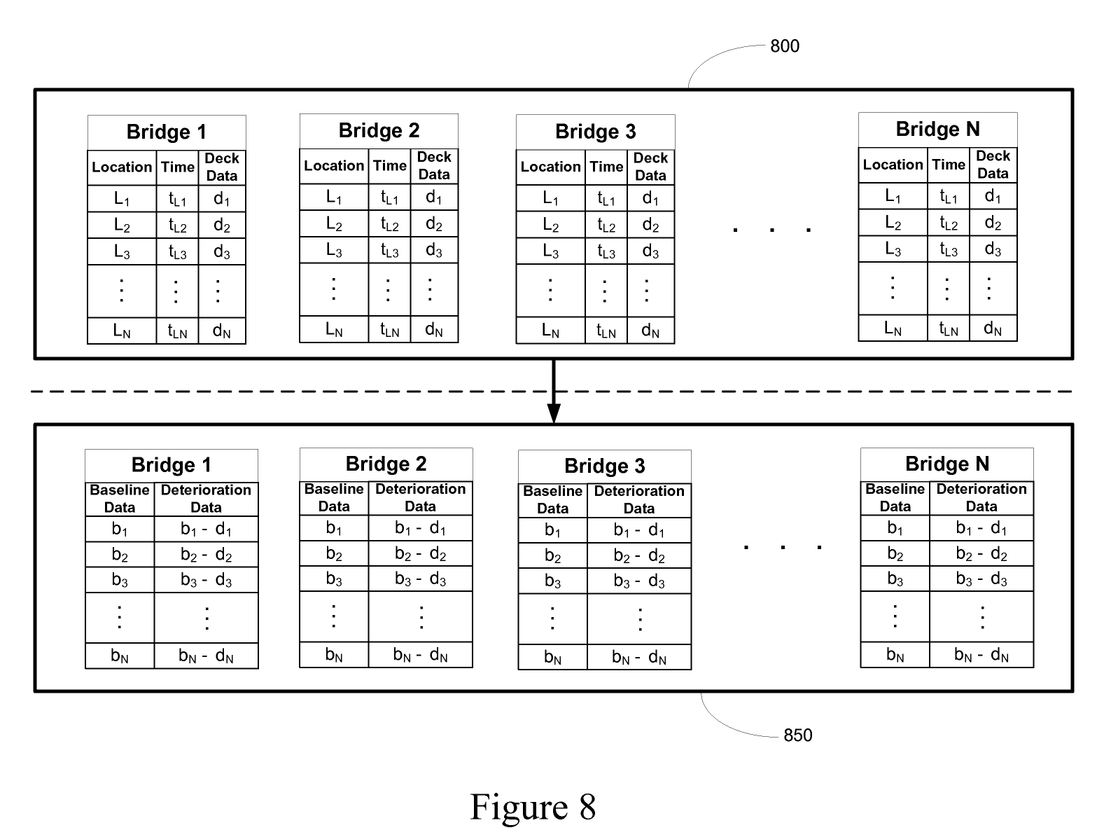

Turning now to FIG. 8, detailed representations of databases 800 and 850 are shown for the first and second systems 735 and 765 illustrated in FIG. 7. The representations of databases 800 and 850 include data structures containing bridge deck data for N bridges of a bridge network. Databases 800 and 850 may be implemented in a common system or separate systems. Database 800 is shown to include data for a multiplicity of bridges. This data includes deck data, deck location data, and time stamp data corresponding to the time that the deck data was acquired for each of a multiplicity of deck probes or scans. A processor is configured to calculate deterioration data for each bridge deck location of each bridge using the data stored in databases 800 and 850.

The baseline data for each bridge is represented by data b₁, b₂, b₃, . . . , b_{N}. Referring to Bridge 1, data b₁ represents the baseline data that is stored in database 850 for location L₁. The deterioration data is calculated by determining the change between the deck data and the baseline data for a specific bridge deck location over time. The deterioration data for each bridge deck is stored according to location as data d₁, d₂, d₃, . . . , d_{N}. For example, data d₃ associated with Bridge 2 represents the change in the Bridge 2 deck data relative to the baseline data for location L₃ over time.

It is noted that the deck data shown in the embodiment of FIG. 8 typically represents or includes adjusted deck data developed using adjusted data indicative of external factors that influence the deck data but are unrelated to a failure mechanism impacting the bridge deck interior. The adjusted data, in other words, incorporates normalization of external factors, such as environmental and external factors, that are unrelated to actual deterioration of the bridge deck (see, e.g., FIGS. 4 and 5 and accompanying text).

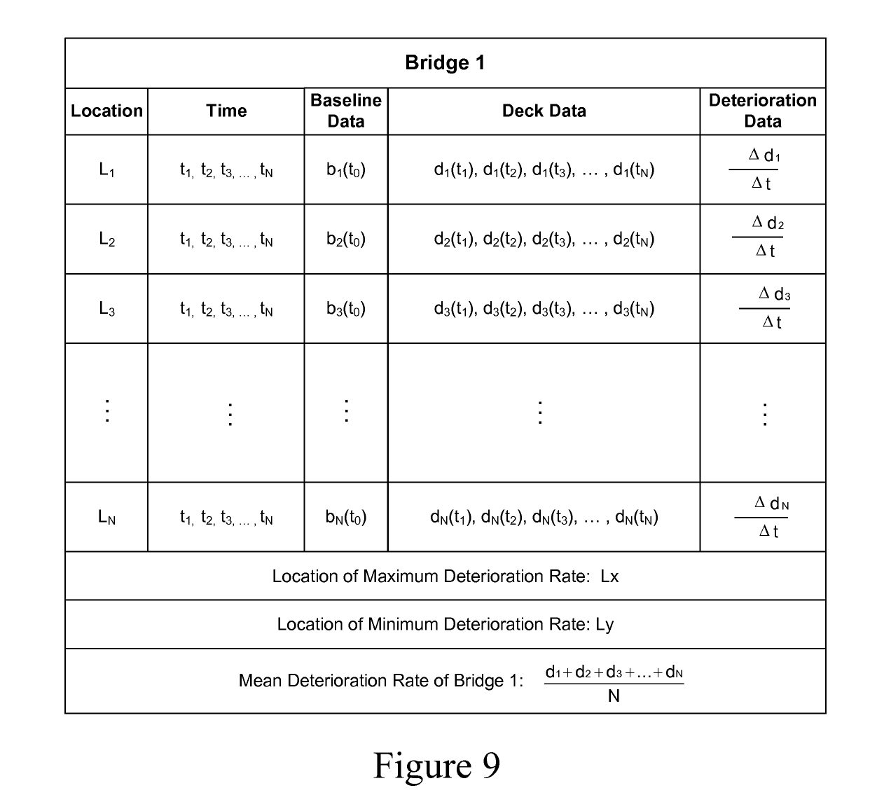

FIG. 9 shows a detailed view of the representative databases 735 and 765 shown in FIG. 7. In FIG. 9, data for only Bridge 1 is shown for clarity of explanation. In FIG. 9, Bridge 1 is probed or scanned at a multiplicity of bridge deck locations. These locations are shown as locations L₁, L₂, L₃, . . . , L_{N}. Sensor data may be obtained at many different times for every location. For example, L₁ has sensor readings at times t₁, t₂, t₃, and so on. Baseline data is also associated with each location of the bridge deck of Bridge 1. The baseline data provides sensor and time stamp data that can be compared with bridge deck data obtained at a later point in time. Deck data is stored at a time subsequent to a time the baseline data was obtained. The deck data at each location can be acquired at a multiplicity of different times. For example, as shown in FIG. 9, the deck data is stored as a function of time.

Deterioration data is stored in the database and preferably includes the rate of deterioration and optionally acceleration of deterioration of the bridge deck which is calculated and transferred to the database. According to various embodiments, deterioration data can be calculated by determining a difference between the deck data at a desired time, for example t₁, and the baseline data, established at a prior time (e.g., time t₀). This difference value can be divided by a difference in time between t₁ and the time the baseline data was established, in this case at time t₀. This computation produces the change in the deck data over time. As mentioned above, it is understood that the acceleration of bridge deck deterioration can also be calculated and used in the assessment.

FIG. 9 also shows the maximum deterioration rate, minimum deterioration rate, and the mean deterioration rate for each bridge deck calculated and stored in the database. These statistical values can be used to stratify bridge decks of a transportation network in terms of condition and maintenance priority.

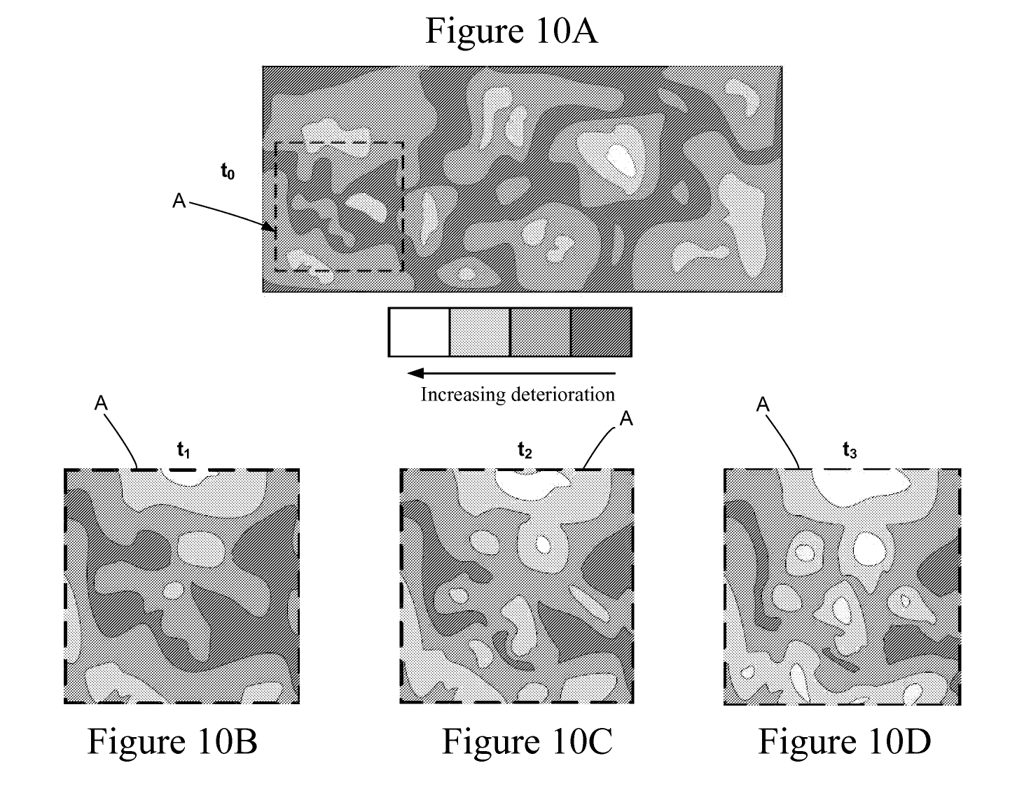

FIG. 10A is a bridge deck deterioration map based on attenuated return signals acquired from a sensor system. Similar to the deterioration contour map shown in FIG. 2, it can be observed that the lighter areas of the map of FIG. 10A correspond to areas of increased bridge deck deterioration. The deterioration map shown in FIG. 10A is representative of baseline bridge deck data obtained at a time t₀. The deterioration maps shown in FIGS. 10B, 10C and 10D are representative of bridge deck data for a region A of the bridge deck shown in FIG. 10A obtained at times t₁, t₂, and t₃, respectively, subsequent to time t₀. For example, the deterioration maps shown in FIGS. 10B, 10C and 10D may be representative of bridge deck data obtained at years 5, 10, and 15 subsequent to time t₀ at which the baseline bridge deck data of FIG. 10A was established.

A rate of deterioration can be calculated based on a time-series of bridge deck deterioration data. According to a “binned threshold” approach, an “average” top rebar mat amplitude is determined over a unit area of the top rebar mat and put into a “bin” of various threshold values. Each average top rebar mat amplitude is then compared to an amplitude baseline or amplitude acquired from previous data collection for the same unit area. One approach to calculating a rate of bridge deck deterioration involves determining the number of unit areas of the top rebar mat that have had their average amplitude move below a predetermined threshold.

A rate of deterioration can be calculated based on a time-series of bridge deck contour maps directly using known techniques. The contour lines of the deterioration maps shown in FIGS. 10A-10D represent GPR return signal amplitude for internal bridge deck locations as a function of time. These contour lines define a curve connecting points where the function has the same particular value. The gradient of the function is perpendicular to the contour lines, and is indicative of a maximum rate of change in bridge deck condition. Where the lines are relatively close together, the magnitude of the gradient is large, indicating that the variation or change in GPR return signal amplitude, and therefore change in bridge deck degradation, is steep.

It is understood that the deterioration maps shown in FIGS. 10A-10D and represented in two-dimensions (2-D) typically incorporate three-dimensional (3-D) sensor data, such as 3-D GPR data. Deck deterioration data may be presented in 3-D, such as by use of known surface plot generation techniques. Surface maps corresponding to interior deck deterioration data may be generated that provides for the use of color zones, independent X, Y, Z scaling, orthographic or perspective projections at any tilt or rotation angle, and different combinations of X, Y and Z lines to produce desired surface map characteristics, for example. It is noted that surface maps representative of bridge deck deterioration data can be overlaid on one another, and that contour maps and surface maps representative of bridge deck deterioration data can be overlaid.

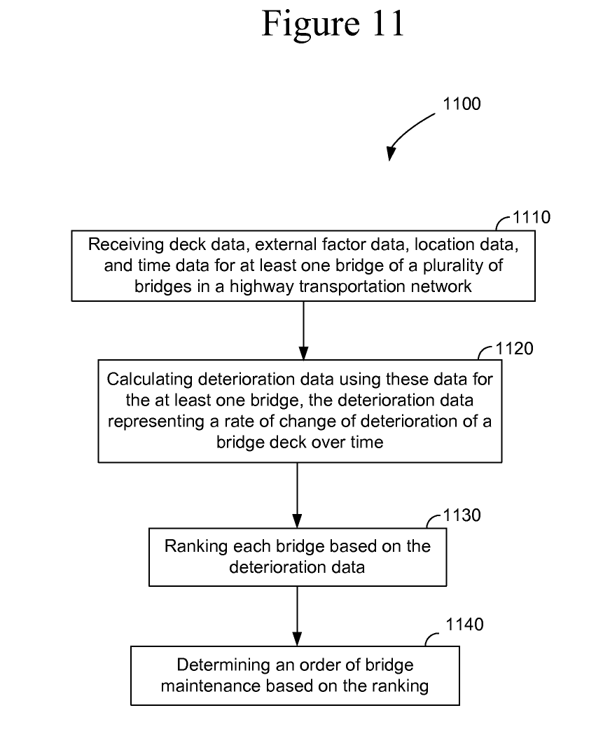

FIG. 11 shows a flowchart illustrating a method 1100 for ranking bridges in a highway transportation network based on bridge deck deterioration in accordance with embodiments of the invention. According to FIG. 11, deck data, external factor data, location data, and time data is received 1110 for at least one bridge of a multiplicity of bridges in a highway transpiration network. Deterioration data is calculated 1120 from the deck data, external factor data, location data, and time data preferably for each bridge (and bridge deck location), where the deterioration data represents a rate of change of deterioration of the bridge deck over time. An aggregate bridge deck deterioration metric can be computed for each bridge deck based on an average or mean of the deterioration data for multiple locations of the bridge deck. Each bridge is ranked 1130 based on the deterioration data. An order of bridge maintenance is determined 1140 based on the ranking 1130. For example, prioritization of bridge maintenance across a network of bridges may involve identifying those bridges in most need of more intensive assessment, which may be indicated by a transformation of a bridge deck deterioration metric to NBI bridge deck condition rating index (e.g., a coding index of 0-9).

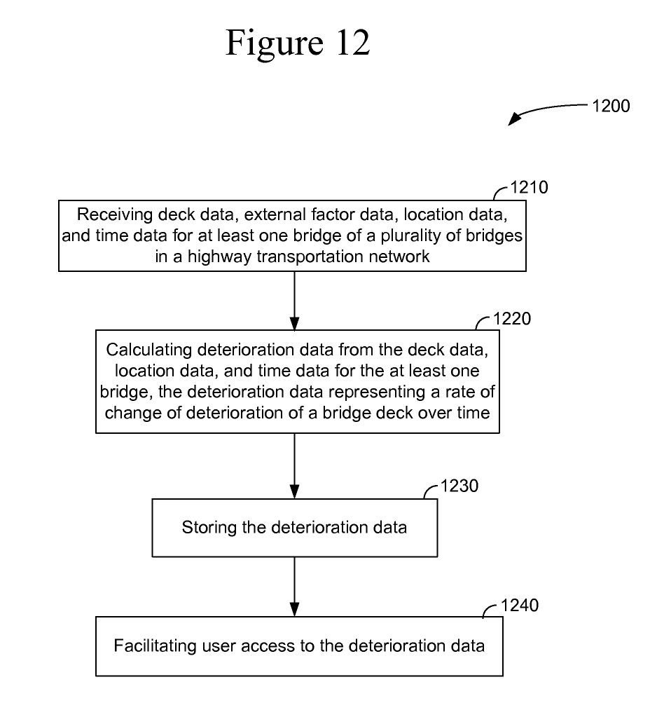

FIG. 12 illustrates a flow chart of a method 1200 for allowing access to bridge deck deterioration data for multiple users. Deck data, external factor data, location data, and time data are received 1210 for at least one bridge of a multiplicity of bridges in a highway transportation network. Deterioration data is calculated 1220 from these data, the deterioration data representing a rate of change of deterioration of a bridge deck over time. The deterioration data is stored 1230 in a database. User access to the deterioration data is facilitated 1240 by a user interface. Access to the bridge deck deterioration data is preferably limited in accordance with a pre-established access strategy. For example, access to various types of bridge deck deterioration data may be granted based on contracts established between the data provider and governmental or private entities, and on a fee or subscription basis.

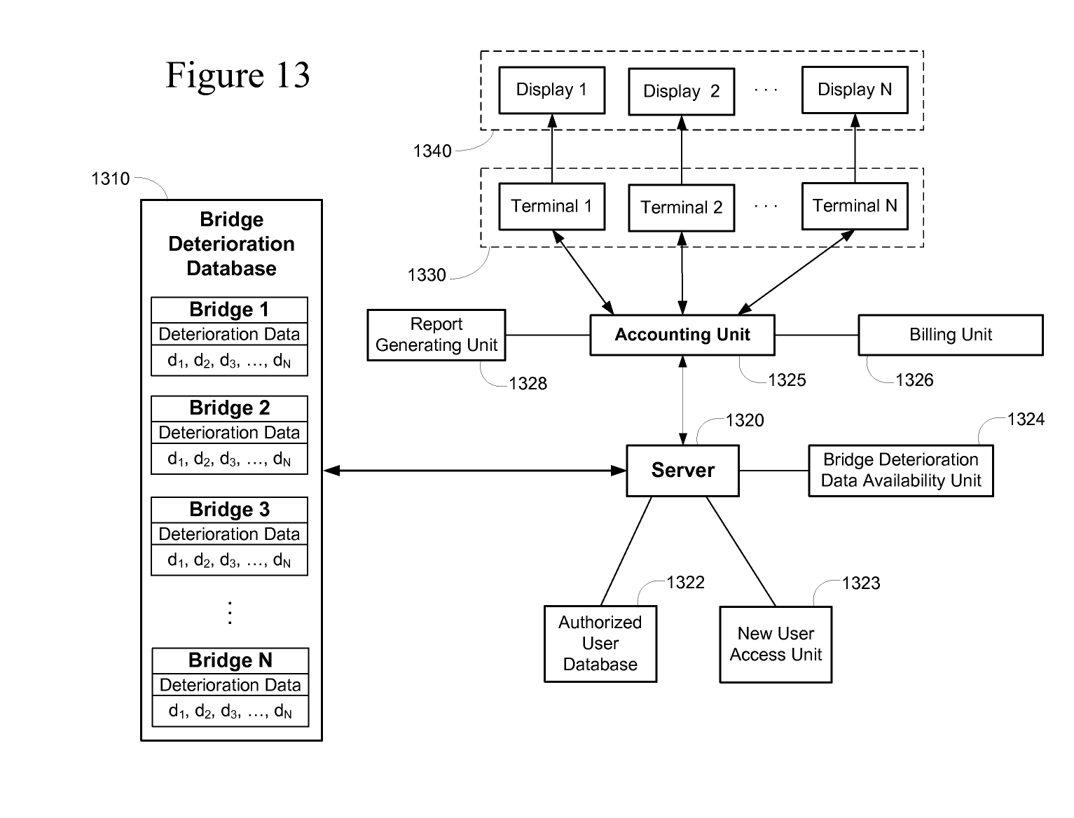

FIG. 13 shows a system diagram in accordance with embodiments of the invention. FIG. 13 illustrates a bridge deterioration database 1310 coupled to a server 1320. The server can be managed to facilitate user access to the database via terminals 1330 and displays 1340.

According to embodiments of the invention, the bridge deterioration database 1310 stores deterioration data for a multiplicity of bridges. The deterioration data for each bridge includes the rate of deterioration (and optionally acceleration and other related data) for various locations on a bridge deck over a period of time. The bridge deterioration database 1310 may store deterioration data separated into groups corresponding to data on bridges located within a specific highway transportation network. All of the bridges in the database 1310 may alternatively be listed separately or separated according to a geographic region. The bridge deck data preferably incorporates other NBI or similar coding in addition to NBI-type bridge deck deterioration data.

The following are codes and information that may be incorporated as part of the bridge deck deterioration data and stored in the database 1310. These data, shown below in Table 2, are described in detail in USDOT FHWA's “Recording and Coding Guide for the Structure Inventory and Appraisal of the Nation's Bridges,” Report No. FHWA-PD-96-001:

TABLE 2

| DATA | ITEMS |
|---|---|
| 1 | State Code |
| 2 | Highway Agency District |
| 3 | County (Parish) Code |
| 4 | Place Code |
| 5 | Inventory Route |
| 6 | Features Intersected |
| 7 | Facility Carried by Structure |
| 8 | Structure Number |
| 9 | Location |
| 10 | Inventory Rout, Minimum Vertical Clearance |
| 11 | Kilometer Point |
| 12 | Base Highway Network |
| 13 | LRS Inventory Route, Subroute Number |
| 14 | (Reserved) |
| 15 | (Reserved) |
| 16 | Latitude |
| 17 | Longitude |
| 18 | (Reserved) |
| 19 | Bypass, Detour Length |
| 20 | Toll |
| 21 | Maintenance Responsibility |
| 22 | Owner |
| 23 | (Reserved) |
| 24 | (Reserved) |
| 25 | (Reserved) |
| 26 | Functional Classification of Inventory Route |
| 27 | Year Built |
| 28 | Lanes On and Under the Structure |
| 29 | Average Daily Traffic |
| 30 | Year of Average Daily Traffic |
| 31 | Design Load |
| 32 | Approach Roadway Width |
| 33 | Bridge Median |
| 34 | Skew |
| 35 | Structure Flared |
| 36 | Traffic Safety Features |
| 37 | Historical Significance |
| 38 | Navigation Control |
| 39 | Navigation Vertical Clearance |
| 40 | Navigation Horizontal Clearance |
| 41 | Structure Open, Posted, or Closed to Traffic |
| 42 | Type of Service |
| 43 | Structure Type, Main |
| 44 | Structure Type, Approach Spans |
| 45 | Number of Spans in Main Unit |
| 46 | Number of Approach Spans |
| 47 | Inventory Route, Total Horizontal Clearance |
| 48 | Length of Maximum Support |
| 49 | Structure Length |
| 50 | Curb or Sidewalk Widths |
| 51 | Bridge Roadway Width, Curb-to-Curb |
| 52 | Deck Width, Out-to-Out |
| 53 | Minimum Vertical Clearance Over Bridge Roadway |
| 54 | Minimum Vertical Underclearance |
| 55 | Minimum Lateral Underclearance on Right |
| 56 | Minimum Lateral Underclearance on Left |
| 57 | (Reserved) |

Condition Ratings

| | |
|---|---|
| 58 | Deck |
| 59 | Superstructure |
| 60 | Substructure |
| 61 | Channel and Channel Protection |
| 62 | Culverts |
| 63 | Method Used to Determine Operating Rating |
| 64 | Operating Rating |
| 65 | Method Used to Determine Inventory Rating |
| 66 | Inventory Rating |

Appraisal Ratings

| | |
|---|---|
| 67 | Structural Evaluation |
| 68 | Deck Geometry |
| 69 | Underclearances, Vertical and Horizontal |
| 70 | Bridge Postings |
| 71 | Waterway Adequacy |
| 72 | Approach Roadway Alignment |
| 73 | (Reserved) |
| 74 | (Reserved) |
| 75 | Type of Work |
| 76 | Length of Structure Improvement |
| 77 | (Reserved) |
| 78 | (Reserved) |
| 79 | (Reserved) |
| 80 | (Reserved) |
| 81 | (Reserved) |
| 82 | (Reserved) |
| 83 | (Reserved) |
| 84 | (Reserved) |
| 85 | (Reserved) |
| 86 | (Reserved) |
| 87 | (Reserved) |
| 88 | (Reserved) |
| 89 | (Reserved) |
| 90 | Inspection Date |
| 91 | Designated Inspection Frequency |
| 92 | Critical Feature Inspection |
| 93 | Critical Feature Inspection Date |
| 94 | Bridge Improvement Cost |
| 95 | Roadway Improvement Cost |
| 96 | Total Project Cost |
| 97 | Year of Improvement Cost Estimate |
| 98 | Border Bridge |
| 99 | Border Bridge Structure Number |
| 100 | STRAHNET Highway Designation |
| 101 | Parallel Structure Designation |
| 102 | Direction of Traffic |
| 103 | Temporary Structure Designation |
| 104 | Highway System of the Inventory Route |
| 105 | Federal Lands Highways |
| 106 | Year Reconstructed |
| 107 | Deck Structure Type |
| 108 | Wearing Surface/Protective System |
| 109 | Average Daily Truck Traffic |
| 110 | Designated National Network |
| 111 | Pier or Abutment Protection (for Navigation) |
| 112 | NBIS Bridge Length |
| 113 | Scour Critical Bridges |
| 114 | Future Average Daily Traffic |
| 115 | Year of Future Average Daily Traffic |
| 116 | Minimum Navigation Vertical Clearance |
| | Vertical Lift Bridge |

As is shown in FIG. 13, data for each bridge stored in the database 1310 has a multiplicity of data sets associated with it. These different data sets correspond to the deterioration data of different locations on the bridge deck. For example, data set d₁ for Bridge 1 corresponds to deck deterioration data acquired for Location 1 of Bridge 1.

The database 1310 may be coupled to a server 1320 which allows access to database 1310 by a multiplicity of users. Multiple users in disparate locations may have access to the bridge deck deterioration data, and other bridge data if included, using terminals 1330 coupled to displays 1340. The server 1320 may be configured to implement a web-based application that facilitates multiple user access via the Internet. The terminals 1330 may allow a user to access deterioration data for bridges in various ways. For example, the user may be able to look up an individual bridge, all bridges in a bridge transportation network, or all bridges in a particular user-selected geographic region. The bridge deterioration database 1310 may additionally contain data relating to the average bridge deck deterioration in a bridge network or geographic region as well as the maximum and minimum deterioration values within those areas. Bridge maintenance priority and resource allocation data may also be incorporated in the server. Bridge maintenance schedules and status of repair data may be incorporated and updated periodically (e.g., daily or weekly) to provide near real-time status of bridge deck inspections and repair efforts.

FIG. 13 also illustrates various business related processing resources and interfaces that may enhance the ability to account and bill users for accessing and using the bridge deterioration database 1310 and ancillary resources. According to various embodiments of the invention, an accounting unit 1325 is coupled between the server 1320 and the user accessible terminals 1330. The server 1320 may interact with an authorized user database 1322 which stores user information needed to distinguish between authorized and unauthorized users of the bridge deterioration database 1310 resources. The authorized user database 1322, for example, may store user names, user IDs, passwords, current address and contact information, and the like for each user having an account that permits access to the bridge deterioration database 1310 resources.

A new user's access unit 1323 provides for on-line registration of a new user to the system. The new user's access unit 1323 allows a new user to establish an account which is then approved by the system and/or system administrator. When approved, the new user data is transmitted to the authorized user database 1322, thus allowing subsequent access to the system by the new user using a standard access procedure established for authorized users.

The accounting unit 1325 shown in FIG. 13 may incorporate or be coupled to a variety of accounting related data processing, storage, and interface resources. For example, a billing unit 1326 may be coupled to the accounting unit 1325 which provides a mechanism for generating electronic or printed billing invoices which are dispatched to users who utilize bridge deterioration database resources. In addition, the billing unit 1326 may store information concerning a user's past payment data and may communicate a delinquency message to the user accessible terminals 1330 which, in turn, may limit or deny access to the system for a delinquent user.

A report generating facility 1328 may also be coupled to the accounting unit 1325 for generating a variety of accounting, financial, resource utilization, diagnostic, and other information associated with the operation and utilization of the bridge deterioration database 1310 and ancillary resources. The reporting unit 1328 may, for example, include a number of monitoring units that monitor a variety of system performance parameters, such as number of users accessing the system, number of bytes of data requested by users, types of data requested, uni-directional or bi-directional data transfer rates and bottlenecks in data flow, and the like.

A bridge deterioration data availability unit 1324 may also be accessed by users. This availability unit 1324, for example, may provide information concerning the present availability of bridge deterioration data for a user selectable region or highway transportation network. For example, a user may wish to query whether bridge deterioration data is available for a given stretch of highway in a particular city. Further, the user may want to know the relative quality or reliability of the data, such as whether the deterioration data was obtained using a conventional manual approach or a sensor-based approach consistent with the principles of the invention (or both). Other data, such as the deterioration data service provider or source (e.g., municipality) that provided the data, the age of the data, and the equipment used to obtain the data, may be made available to a user. The bridge deterioration data availability unit 1324 provides users with this and other detailed information concerning the type of bridge deterioration data available for a specified area or location.

Embodiments of the invention are directed to an analytical process that integrates a time-series comparison of sensor data (e.g., 3-D GPR data) at the network-level within the bridge deck management decision process. Such a process offers significant value, cost-savings, energy-savings, and enhanced safety to DOT's and other transportation infrastructure owners/managers by better prioritizing their funding decisions and allowing for future planning because of the addition of an objective, internal bridge deck deterioration rate assessment that is presently not available.

A deterioration metric (or metrics) generated in accordance with embodiments of the invention provide DOT's and other bridge owners with a quantitative means to prioritize preventative maintenance and repair resources on those bridges determined to be most rapidly deteriorating and approaching deficiency, based on an internal assessment that cannot be achieved during routine visual examinations. Importantly, calculating the bridge deck deterioration rate through a time-series analysis of the present invention provides a direct measurement of how bridge deck systems and materials are performing with respect to their intended life-cycle.

Although it is acknowledge that GPR and other sensor-based assessment tools cannot replace visual inspection techniques, incorporation of sensor-based assessment tools adds value as a significant enhancement to required biennial visual inspection efforts. Including continuous, internal bridge deck information is critical to a more evolved infrastructure management process where the combined data provide a complete database for system-wide comparisons of external and internal deck condition for purposes of ranking projects, developing short- and long-term management goals, and/or allocating funds within short- or long-term budget cycles.

The discussion and illustrations provided herein are presented in an exemplary form, wherein selected embodiments are described and illustrated to present the various aspects of the present invention. Systems, devices, or methods according to the present invention may include one or more of the features, structures, methods, or combinations thereof described herein. For example, a device or system may be implemented to include one or more of the advantageous features and/or processes described herein. A device or system according to the present invention may be implemented to include multiple features and/or aspects illustrated and/or discussed in separate examples and/or illustrations. It is intended that such a device or system need not include all of the features described herein, but may be implemented to include selected features that provide for useful structures, systems, and/or functionality.

What is claimed is:

1. An apparatus supportable by a transport unit capable of traversing a highway route that includes a highway bridge having a bridge deck, the apparatus comprising:
a sensor system comprising a coupling arrangement that couples the sensor system to the transport unit, the sensor system configured to probe an interior volume of the bridge deck at one or more locations of the deck and to produce deck data useful for assessing internal degradation of the bridge deck;
a geographic positioning unit configured to determine a geographic position of the sensor system as the transport unit and the sensor system traverse at least the deck;
memory configured to store geographic positioning data and the deck data provided by the geographic positioning unit and the sensor system, respectively; and
a processor configured to associate the deck data with the one or more deck locations using the geographic positioning data, the processor configured to generate adjusted deck data using adjustment data indicative of external factors that influence the deck data but are unrelated to a failure mechanism impacting the bridge deck interior, the processor further configured to generate an output comprising at least the adjusted deck data.

2. The apparatus of claim 1, wherein the sensor system comprises a ground penetrating radar sensor.

3. The apparatus of claim 1, wherein the sensor system comprises a ground penetrating radar system including an air-launched antenna arrangement, the ground penetrating radar system configured to produce the deck data while the transport unit traverses the bridge deck at posted road speeds.

4. The apparatus of claim 1, wherein the sensor system comprises an impact-echo sensor or a micro-seismic sensor.

5. The apparatus of claim 1, wherein:
the sensor system comprises a plurality of disparate sensors that produce a plurality of disparate deck data sets; and
the processor is configured to fuse the plurality of disparate deck data sets to produce fused deck data associated with each of the one or more deck locations.

6. The apparatus of claim 1, wherein the sensor system is configured to sense reinforced concrete components of the bridge deck interior.

7. The apparatus of claim 1, wherein the sensor system is configured to sense at least a top surface of a rebar mat or a cage of the bridge deck interior.

8. The apparatus of claim 1, wherein the sensor system comprises a ground penetrating radar system, the ground penetrating radar system configured to measure radar return signal attenuation at a top surface of a rebar mat or a cage of the bridge deck interior.

9. The apparatus of claim 1, wherein the adjustment data indicative of external factors that influence the deck data comprises data associated with at least one of ambient temperature, ambient moisture, presence of deicing substances, and GPR antenna wander affect.

10. The apparatus of claim 1, wherein processor is disposed on-board the transport unit.

11. The apparatus of claim 1, wherein the processor is disposed in a processing system external of the transport unit.

12. An apparatus supported by a transport unit capable of traversing a highway route that includes a highway bridge having a bridge deck, the apparatus comprising:
a sensor system comprising a coupling arrangement that couples the sensor system to the transport unit, the sensor system configured to probe an interior volume of the bridge deck at one or more deck locations and to produce deck data useful for assessing internal degradation of the bridge deck;
a geographic positioning unit configured to determine a geographic position of the sensor system as the transport unit and the sensor system traverse at least the deck;
a time reference configured to generate a time stamp indicative of a time when deck data and geographic positioning data are acquired;
memory configured to store geographic positioning data the deck data, and time stamp data provided by the geographic positioning unit, the sensor system, and the time reference, respectively;
a processor configured to associate the deck data with the one or more deck locations using the geographic positioning data and the time stamp data, and to generate time-stamped geographic positioning and deck data sets (data sets);
a database configured to store a plurality of time-separated data sets for each bridge of a multiplicity of bridges of a highway transportation network, at least one of the data sets for each bridge defining a baseline data set for said bridge;
the processor configured to:
compare, for each bridge, the baseline data set to one or more of the data sets developed subsequent in time to the baseline data set for said bridge;
produce deterioration data based on the comparison, the deterioration data indicating a degree of bridge deck deterioration having occurred between times when the respective data sets were developed based on their respective time stamps; and
generate an output comprising an indication of bridge deck deterioration for each bridge of the transportation network.

13. The apparatus of claim 12, wherein the processor is configured, for each bridge, to produce deterioration data for each of a plurality of disparate locations of said bridge, and generate an output comprising an indication of deterioration at each of the disparate bridge locations of each bridge.

14. The apparatus of claim 12, wherein the processor is configured to produce, for each bridge, a deterioration metric of bridge deck deterioration based on the comparison, and generate an output comprising the deterioration metric for each bridge.

15. The apparatus of claim 14, wherein the deterioration metric corresponds to a condition rating conforming to a National Bridge Inventory (NBI) format.

16. The apparatus of claim 12, wherein the processor is configured to produce, for each of a plurality of disparate locations for each bridge, a deterioration metric of bridge deck deterioration for each disparate location based on the comparison, and generate an output comprising the deterioration metric for the disparate locations of each bridge.

17. The apparatus of claim 12, wherein the deterioration data comprises a magnitude of bridge deck deterioration having occurred between times when the respective data sets were developed based on their respective time stamps.

18. The apparatus of claim 12, wherein the deterioration data comprises a rate of bridge deck deterioration having occurred between times when the respective data sets were developed based on their respective time stamps.

19. The apparatus of claim 12, wherein the deterioration data comprises an acceleration of a rate of bridge deck deterioration having occurred between times when the respective data sets were developed based on their respective time stamps.

20. The apparatus of claim 12, wherein the processor is configured to compute at least one of a maximum, a mean, and a minimum rate of deterioration for each bridge.

21. The apparatus of claim 12, wherein the processor is configured to compute at least one of a maximum, a mean, and a minimum rate of deterioration for each of a plurality of disparate locations of each bridge.

22. The apparatus of claim 12, wherein the processor is configured to cooperate with the database to generate an output comprising deterioration data for all bridges of the transportation network.

23. The apparatus of claim 12, wherein the database is configured to store time-separated data sets for each bridge that are separated in time by at least about 1-3 years.

24. The apparatus of claim 12, wherein the database is configured to store time-separated data sets for each bridge that are separated in time by at least about 3-6 years.

25. The apparatus of claim 12, wherein the database is configured to store time-separated data sets for each bridge that are separated in time by up to at least about 10 years.

26. The apparatus of claim 12, wherein the processor is configured to prioritize the bridges in terms of deterioration severity based on the deterioration data stored in the database.

27. The apparatus of claim 12, wherein the processor is configured to prioritize maintenance requirements for the plurality of bridges based on the deterioration data stored in the database.

28. A method, comprising:
probing an interior volume of the bridge deck using a transportable sensor system to produce deck data useful for assessing internal degradation of the bridge deck;
determining a geographic position of the sensor system as the sensor system traverses the deck and producing geographic positioning data;
associating the deck data with the one or more deck locations using the geographic positioning data;
generating adjusted deck data using adjustment data indicative of external factors that influence the deck data but are unrelated to a failure mechanism impacting the bridge deck interior; and
generating an output comprising at least the adjusted deck data.
